(19) United States
(12) Patent Application Publication
(10) Pub. No.: US 2024/0315341 A1
(43) Pub. Date: Sep. 26, 2024

(54) Aerosol Generating Device and Method of Generating an Aerosol

(71) Applicant: JT International SA, Geneva (CH)

(72) Inventors: Jaakko McEvoy, Vienna (AT); Christoph Lungenschmied, Vienna (AT)

(73) Assignee: JT International SA, Geneva (CH)

(21) Appl. No.: 18/577,469

(22) PCT Filed: Jul. 13, 2022
(86) PCT No.: PCT/EP2022/069610

§ 371 Date: Jan. 8, 2024

(30) Foreign Application Priority Data
Jul. 14, 2021 (EP) 21185533.3

(51) Int. Cl. A24F 40/465; A24F 40/10; A24F 40/44; A24F 40/485; A24F 40/51

(52) U.S. Cl. CPC A24F 40/465; A24F 40/10; A24F 40/44; A24F 40/485; A24F 40/51

(57) ABSTRACT

An aerosol generating device has a base with open microchannels, which are at least partially covered by a heatable mesh, which is inductively or indirectly heatable by means for inductively or indirectly heating the mesh, such as such as the base and/or a contacting heater and/or a heat transfer membrane and/or a susceptor. Further, a method of generating an aerosol from a base with open microchannels, which are at least partially covered by a mesh, is presented, in which the mesh is inductively or indirectly heated.

### TECHNICAL FIELD

The invention relates to an aerosol generating device and a method of generating an aerosol.

In recent years, conventional smoking products have been more and more replaced by aerosol generating devices, in which a liquid is evaporated and can be inhaled by a user.

### TECHNICAL BACKGROUND

In this context, U.S. Pat. No. 10,172,388 B2 is related to a vaporizer, in which capillary channels are covered by a perforated cover, which can be in the form of a mesh and is formed of heat stable material.

Similarly, WO 2021/110438 A1 discloses a vaporizer having a substrate with channels with a resistive heating element provided as a layer at the outlet side of the substrate.

Finally, US 2020/0397052 A1 is related to an inhaler with closed channels, which are covered by a heating element at ends thereof.

### SUMMARY OF THE INVENTION

Against this background, it is an object underlying the invention to improve an aerosol generating device and a corresponding method with regard to the flow of liquid to be vaporized and/or vaporizing of the liquid.

This is achieved by means of the subject matter of claims 1 and 14.

Accordingly, an aerosol generating device has a base with open microchannels, which are at least partially covered by a heatable mesh, e.g. woven from metal wires. The mesh, firstly, aids in the capillary wicking which happens in the micro channels. In other words, micro channels act as liquid delivery paths similar to wicks and transport the liquid to be vaporized. This capillary action is enhanced by the mesh covering the microchannels. Moreover, since vaporization at least partly happens through the mesh, the heatable mesh transfers heat to the liquid and promotes vaporization thereof by increasing the surface area for vaporization. The heatable mesh thus increases the heat transfer coefficient as well as the critical heat flux. Moreover, unlike known solutions, in which a directly heatable mesh may be provided in contact with a wick, the mesh is in this embodiment essentially provided in parallel with the flow direction of the liquid and allows vaporization through the mesh, in other words, essentially perpendicular to the flow direction. This provides additional versatility for the design of an aerosol generating device.

It will be understood that the base is thus made of solid material, such as a metal, a semiconductor or insulator, such as polymers/plastics or ceramics. Nevertheless, the mesh can be covered by a wick at a side opposite the base.

Further, the microchannels can be called horizontal, as they extend, when they are substantially straight, along a longitudinal axis of the aerosol generating device and are open in a direction perpendicular thereto. According to the invention, they are covered in this direction by the mesh. Moreover, the mesh is a component separate and/or separable from the base unlike a layer integrally provided on the base.

In another embodiment, the base does typically not have straight channels, but channels of any shape which are essentially formed by open porosity, in other words connected pores formed in the base. Such a base can generally be formed of soft fibrous material, but will preferably be formed of solid material, such as ceramics. Moreover, in connection with this embodiment, the base is essentially formed by a porous wick and will be called a wick in connection with FIGS. 5 to 7. In this embodiment, the channels are essentially open at the outer surfaces of the wick, and this is essentially where they are covered by the inductively or indirectly heatable mesh. In other words, the mesh is typically adjacent, preferably with surface contact, the wick constituting the base in this case. Since any reference to “horizontal”, “being covered” and similar terms anyway depends on how the device is held, it is obvious that the mesh does not necessarily always have to be on top of a base having straight micro channels.

Evaporation in this embodiment was described above. In the embodiment having a porous wick forming the base, the wick can have channels as shown in FIG. 6, and the vapor can be drawn from these channels. However, the wick can be without such essentially straight channels, but can only have channels formed by connected pores, and in this case an airflow can be provided around the wick so as to draw or suck the vapor from the wick.

Further, the mesh is inductively or indirectly heatable by means for inductively or indirectly heating the mesh, such as the base and/or a contacting heater and/or a heat transfer membrane and/or a susceptor. This provides significant advantages over a directly heated mesh, such as a resistively heated mesh. In particular, according to the invention, there is no need for electrical contacts on the mesh, which are generally difficult to align and require the use of gold plating for good contact, which is expensive and difficult to recycle. Further, the resistance of a mesh heatable by resistive heating needs to be carefully engineered as the mesh would in this case be directly connected to a battery. For example, if the resistive heating mesh is made from a semiconductor material, the doping profile thereof has to be very well controlled.

Thus, by means of a sufficient wicking rate, a flow rate of the liquid to be vaporized, and an amount of vapor produced can be increased, so that drying out can be avoided, and the user will always be provided with a pleasant mouth feeling. Further, the heater, such as the heatable base, any contacting heater or a susceptor as well as the optional heat transfer membrane can advantageously be provided in the device itself rather than in the consumable or pod. In another embodiment the heat transfer membrane is provided in the consumable/pod.

Preferred embodiments are described in the further claims.

In order to further increase the heat transferred to the liquid, also the base can be heatable.

As regards liquid transfer to the base, for example, from a reservoir, a preferably unidirectional wick and/or a fluid channel having at least one pump can be provided. E.g., some sort of micropump for example found in the medical industry and/or offered by Fraunhofer can be used.

In connection with the latter alternative, in order to minimize the pressure loss, the pump should be located as close as possible to the inlet side of the base. A maximum distance may be 100, preferably 5 and most preferred 2 mm, and a minimum distance of 1 mm may be beneficial in order to avoid heat from the base and/or the mesh negatively affecting the pump. The pump can, for example, be a piezoelectric pump. In an embodiment, in which the base has plural microchannels, a flow plenum can be provided to ensure even flow distribution, and a flow inlet at the first plenum can, for example, be normal to the flow direction of the liquid in the microchannel. The pump can then be arranged directly before the inlet plenum port and advantageously with the outlet of the pump connecting directly to the inlet plenum port.

It should be mentioned that the liquid can be provided for evaporation in an open loop configuration. However, also a closed loop configuration can be provided, in which any unevaporated liquid is returned to a reservoir, preferably via a one-way valve. In an open system, a pressure sensor can advantageously be provided to control the flow rate in the micro channels.

In order to leave the pressure sensor or transducer unaffected by heat, it is preferably spaced from the heatable mesh and/or base, by at least 1 mm. This particularly applies to resistance or induction heating being used in the base and/or the mesh. With normal power levels and reasonable insulation, a spacing of 1, preferably 2 mm will be acceptable, but with high power levels and/or less insulation, spacings of 10 mm or more may be appropriate.

Moreover, any spacing will reduce interference by electromagnetic frequencies. In any case, the distance should provide enough thermal insulation to allow the pressure sensor to operate in a stable temperature range, e.g. taking into account a maximum temperature defined by the sensor manufacturer, such as +85 C, which is common for sensors in such devices.

Particularly high flow rates can be achieved, when the base and/or the mesh and/or one or more channels are at least partially coated so as to increase hydrophilicity. This can be achieved by chemical surface coatings, which can, for example, be applied by UV light irradiation, direct current magnetron sputtering, spray coating, pulsed laser treatment OTS mixture immersion or layer by layer self-assembly and liquid phase deposition or any mixtures thereof.

The mesh can, for example, be made of a single-layer alloy mesh, which can be bonded to the base, for example, by diffusion bonding.

As regards an advantageous hydraulic diameter of the microchannels, a range between 900 nm and 1 mm, preferably between 50 and 600 μm have proven beneficial. The dimensions and geometry will depend on the vaporizable liquid, in particular characteristics of the liquid such as viscosity and surface tension and can thus be appropriately adapted. In this context, also nucleation phenomena for different fluids can be taken into account.

This also applies to a porosity of the mesh in the range of 0.5 to 0.85, preferably about 0.67. It is noted that if the fluid channel is pressurized for flow then the porosity needs to be lower. The porosity can, for example, be controlled by the mesh wire diameter and/or the weave density.

Depending on the design of the aerosol generating device, the base can advantageously have a rectangular, square, circular or oval footprint.

In case of a rectangular footprint, straight microchannels, preferably extending parallel to two sides of the footprint are preferred. In case of a circular or oval footprint, radially extending microchannels will be beneficial. In either case, homogeneous delivery of liquid will be supported by the described layout of the microchannels.

The method according to the invention essentially corresponds to the gist of the device described above, and it should be noted that any features disclosed above and below with regard to the device only are equally applicable to the method and vice versa.

### BRIEF DESCRIPTION OF THE DRAWINGS

Hereinafter, the invention will be described with reference to exemplary embodiments thereof, in which

FIG. 1 shows a front view of a base covered with a mesh,

FIG. 2 schematically shows a major part of an aerosol generating device in a first embodiment in a side view,

FIG. 3 schematically shows a major part of an aerosol generating device in a second embodiment in a side view,

FIG. 4 schematically shows a major part of an aerosol generating device in a third embodiment in a side view, and

FIG. 5-7 schematically show arrangements according to the invention alternative to that of FIG. 1.

### DETAILED DESCRIPTION OF EMBODIMENTS

As can be taken from FIG. 1, the base 10 of an aerosol generating device comprises a number of microchannels 12 which in FIG. 1 extend perpendicular to the plane of the drawings. The microchannels are essentially defined by a bottom 14 as well as sidewalls 16 and intermediate walls 18 of the base 10. In the embodiment shown, all of the mentioned walls 16, 18 are essentially parallel to each other and essentially perpendicular to the bottom 14. Parallel to the bottom 14 is a heatable mesh 20 covering the microchannels 12. As indicated by +/−, the mesh 20 and, in the embodiment shown, also the base 10 is heatable, in the case shown by resistance heating. For this purpose, a resistive heater track 22 is provided adjacent the bottom 14. However, heating according to the invention is effected inductively or indirectly, such as by contact to a heater, a heat transfer membrane or a susceptor. Such contact can be made by pressure, welding, gluing or other type of bonding.

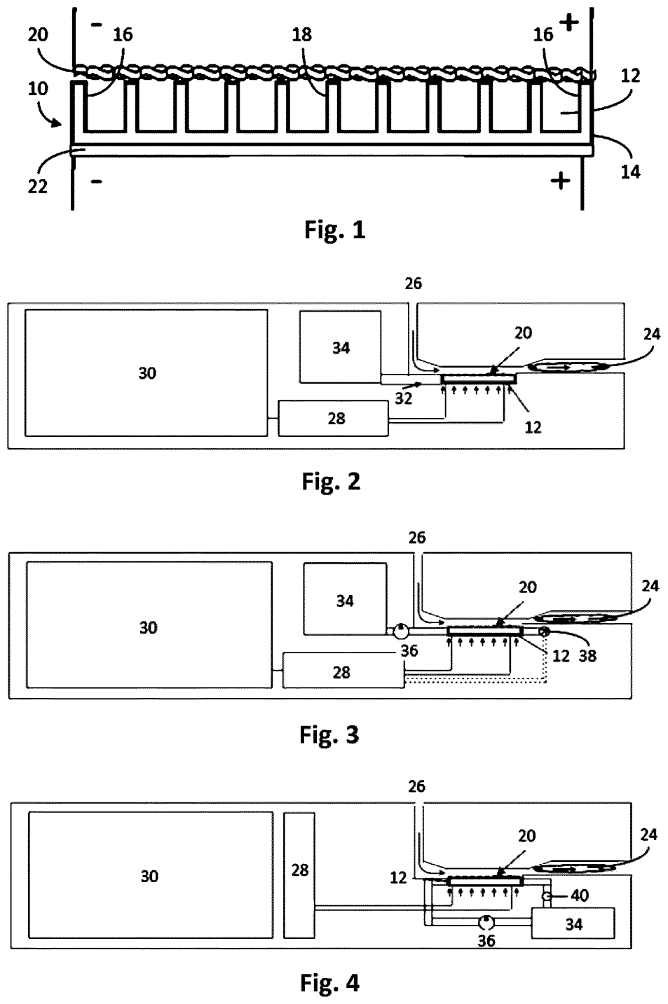

According to FIG. 2 to 4, the flow direction of the liquid is from left to right, and an aerosol 24 is produced from the vaporized liquid together with air 26 drawn in from outside. As can be taken from FIG. 2 to 4, a controller 28 is provided to control heating, and a battery 30 supplies the necessary energy. Moreover, the liquid is transferred to the microchannels 12 in the embodiment of FIG. 2, by means of a unidirectional wick 32 from a reservoir 34.

In contrast, this liquid transport to the base is effected by a pump 36 according to the embodiment of FIG. 3, and a pressure sensor 38 can be provided downstream of the micro channels.

Both the embodiment of FIG. 2 and that of FIG. 3 are open-loop systems, whereas the embodiment of FIG. 4 is a closed loop, as any non-evaporated liquid is returned to the reservoir 34 through a one-way valve 40. The remaining structure is essentially identical and serves to provide improved transfer and vaporization of the liquid, as described above.

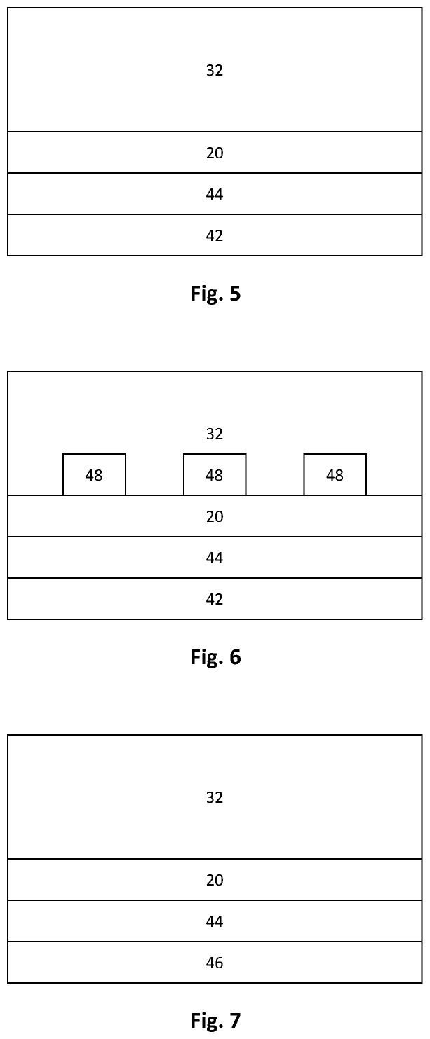

FIG. 5 schematically shows a mesh 20 in this case covered by a wick 32 and heatable by a heater 42 with a heat transfer membrane 44 inbetween. The wick 32 in this case constitutes the base and has channels formed by connected pores as detailed above. As shown in figure, the wick 32 is in this case on top but, as mentioned, this depends on the orientation of the device and it is sufficient for the wick 32 to be adjacent the mesh 20. In the orientation of FIG. 5, liquid can be supplied to the wick 32 from the top.

The heater 42 may be a resistive heater and heat generated therein will be transferred by the heat transfer membrane 44 to the mesh 20 in order to indirectly heat the latter. Also in this embodiment, the mesh 20 leads to fast evaporation and serves to spread evenly the evaporation of the liquid across the mesh and, moreover, advantageously avoids direct contact between the wick 32 and the heater 42.

As can be taken from FIG. 6, essentially the same effect and method of generating an aerosol can be obtained by an alternative arrangement, in which the wick 32 is provided with air channels 48 which may or may not extend straight and/or in parallel to each other.

According to the embodiment of FIG. 7, the mesh is indirectly heated by a susceptor 46 interacting with a coil (not shown) so as to cause currents, such as eddy currents, in the susceptor 46, which will heat same. It is noted that also the mesh 20 itself could be inductively heatable in this manner.

Also in the embodiment of FIG. 7 the wick 32 can have air channels, and in all embodiments shown in the figures and described above the heat transfer membrane can be omitted.

Any one of the arrangements of FIG. 5 to 7 can replace the arrangement of base 10 with microchannels 12 and mesh 20 shown in FIG. 2 to 4. In this case, the wick 32 shown in FIG. 2 might be dispensable, as the wick 32 shown in FIGS. 5 to 7 will have the ability to draw liquid from a reservoir due to capillary forces acting in the open porosity.

### LIST OF REFERENCES

10 Base
12 Microchannel
14 Bottom
16 Sidewall
18 Intermediate
   wall
20 Mesh
22 Heater track
24 Aerosol
26 Air
28 Controller
30 Battery
32 Wick
34 Reservoir
36 Pump
38 Pressure
   sensor
40 One way valve
42 Heater
46 Susceptor
48 Air channel

1. An aerosol generating device comprising a base with open microchannels, which are at least partially covered by a heatable mesh, which is inductively or indirectly heatable by means for inductively or indirectly heating the mesh, wherein the means for inductively or indirectly heating the mesh comprises: the base and/or a contacting heater and/or a heat transfer membrane and/or a susceptor.

2. The aerosol generating device of claim 1, wherein the base is heatable.

3. The aerosol generating device of claim 1, wherein the base is in fluid connection with a unidirectional wick and/or a fluid channel having at least one pump.

4. The aerosol generating device of claim 3, further comprising at least one pump spaced from the base by a minimum of 1 mm and/or a maximum of 100.

5. The aerosol generating device of claim 1, wherein the base is in fluid connection with an outlet channel having a pressure sensor.

6. The aerosol generating device of claim 5, wherein the pressure sensor is spaced from any heatable component by at least 1 mm.

7. The aerosol generating device of claim 1, having further comprising a reservoir between an outlet and an inlet end of the base, with a one way valve upstream of the reservoir.

8. The aerosol generating device of claim 1, wherein at least one of the base or the mesh or one or more channels is at least partially coated so as to increase hydrophilicity.

9. The aerosol generating device of claim 1, wherein the mesh is made of a sintered single layer alloy mesh.

10. The aerosol generating device of claim 1, further comprising a hydraulic diameter of the microchannels ranging between 900 nanometers and 1 millimeter.

11. The aerosol generating device of claim 1, wherein the mesh has a porosity of 0.5 to 0.85.

12. The aerosol generating device of claim 1, wherein the base has a rectangular, square, circular or oval footprint.

13. The aerosol generating device of claim 1, wherein the microchannels extend substantially straight, in case of a rectangular footprint of the base parallel to two sides, or in case of a circular or oval footprint radially.

14. A method of generating an aerosol from a base with open microchannels, which are at least partially covered by a mesh, wherein the mesh is inductively or indirectly heated.

15. The method of claim 14, wherein the base is heated.
